(19) United States
(12) Patent Application Publication
(10) Pub. No.: US 2015/0018262 A1
(43) Pub. Date: Jan. 15, 2015

(54) Aluminum-Safe Surface Presoak Cleaner and Process

(71) Applicant: Zep IP Holding LLC, Atlanta, GA (US)

(72) Inventors: Suhall Massad, Marietta, GA (US); Bin Wu, Marietta, GA (US); Chris Allan Shewmaker, Dunwoody, GA (US); Sekhar Katta, Lawrenceville, GA (US); Enrique Francis, John's Creek, GA (US); Robert Beach, Atlanta, GA (US); Teresa Wolf, Marietta, GA (US); Clark Miller, Norcross, GA (US); Stanley R. Weller, Marietta, GA (US)

(21) Appl. No.: 14/327,815

(22) Filed: Jul. 10, 2014

Related U.S. Application Data
(60) Provisional application No. 61/845,009, filed on Jul. 11, 2013.

(51) Int. Cl. C11D 3/04; C11D 3/20; C11D 3/43; C11D 3/08; C11D 1/00

(52) U.S. Cl. CPC C11D 3/044; C11D 3/08; C11D 1/00; C11D 3/43; C11D 3/2068
USPC 510/197; 510/272; 510/218

(57) ABSTRACT

A presoak cleaning compound and cleaning process developed for compatible application to aluminum and common cooking surfaces including stainless steel, steel, ferrous, plastic or coated cooking surfaces including baking pans and sheet pans, or commonly used substrate materials for food preparation and cooking surfaces of food stuffs for the removal of food soils, baked on food soils, and soils resulting from the preparation and cooking of food stuffs without discoloration, tarnishing, or pitting of the surface.

### CROSS-REFERENCE TO RELATED APPLICATIONS

The present application claims the benefit of priority of U.S. Provisional Application No. 61/845,009 filed Jul. 11, 2013, which is incorporated herein by reference.

### BACKGROUND OF THE INVENTION

The state of the art for cleaning food soils and baked on food soils at time of invention constituted applications of highly alkaline compounds to soiled surfaces combined with application of mechanical abrasion by scrubbing brushes, scrubbing pads, or other mechanical means of removal. Applications of conventional highly alkaline compounds are limited to compatible surfaces including stainless steel, porcelain, non-aluminum surfaces, and surfaces that are not damaged by mechanical abrasion if required in conjunction for removal of soils. Aluminum surfaces are susceptible to reaction with alkaline cleaners particularly cleaners designed for the removal of difficult to remove soils such as baked on food soils and burnt carbon and application of conventional alkaline cleaners typically result in surface damage including discoloration, tarnishing, or pitting. Conventional alkaline cleaners are therefore not used for applications to aluminum surfaces.

### SUMMARY OF THE INVENTION

Embodiments of the invention provide presoak cleaning compositions and methods of pre-soaking aluminum, steel, stainless steel, ferrous, silicone, plastic, or coated surfaces including baking pans and sheet pans, or commonly used substrates for food preparation and cooking surfaces is disclosed which avoids discoloring, tarnishing, pitting, or submitting surfaces to corrosive chemical attack during the removal of food soils, baked on food soils, and soils resulting from the preparation, and cooking of food stuffs including greases, baked-on greases, burnt carbon, and other common residues found on surfaces in kitchens and bakeries. A presoak cleaning composition in embodiments of the invention comprises an alkaline component having one alkali metal hydroxide or a mixture of alkali metal hydroxides, a corrosion inhibitor component having one alkali silicate or a mixture of alkali silicates, an amine component having morpholine, ethanol and propanol, mono, di, and tri amines, an oxygenated solvent component having a glycol ether solvent or a mixture of glycol ether solvents, a surfactant having anionic, cationic, amphoteric, or nonionic or a mixture of anionic, cationic, amphoteric, or nonionic surfactants, and water.

Advantages of aluminum-safe surface presoak cleaners and processes of the present invention include: (i) application to soiled surfaces without discoloring, tarnishing, or pitting particularly of aluminum surfaces and also of steel, stainless steel, ferrous, silicone, plastic, or coated surfaces including baking pans and sheet pans, or commonly used substrates for food preparation and cooking surfaces and (ii) removal of food soils and hard to remove food soils including baked on food soils, and soils resulting from the preparation, and cooking of food stuffs including greases, baked-on greases, burnt carbon, and other common residues found on surfaces in kitchens and bakeries from aluminum, steel, stainless steel, ferrous, silicone, plastic, or coated surfaces including baking pans and sheet pans, or commonly used substrates for food preparation and cooking surfaces with no or minimized need of mechanical abrasion.

### DETAILED DESCRIPTION OF THE INVENTION

In one embodiment of the invention, a presoak cleaning composition which avoids discoloration, tarnishing, or pitting of aluminum surfaces in pre-soak operations comprises one alkali metal hydroxide or a mixture of alkali metal hydroxides and one alkali silicate or a mixture of alkali silicates in the ratio of about 1:1 to 1:50 (normality of hydroxide to normality of silicate), wherein alkali silicate is present in an amount up to about 40% by weight of the composition.

In some embodiments, the alkali metal hydroxide is sodium hydroxide and the alkali silicate is potassium silicate in ratio of about 1:1 to 1:50 (normality of hydroxide to normality of silicate), wherein potassium silicate is present in an amount to about 40% by weight of the composition; preferably, sodium hydroxide to potassium silicate is in the ratio of 1:1.3 to 1:1.7 (normality of hydroxide to normality of silicate), wherein potassium silicate is present in an amount of 2% to 10% by weight of the composition.

In some embodiments, the presoak cleaning composition may include an ammoniated solvent agent, wherein the ammoniated solvent agent is from the group consisting of ethanol and propanol mono, di, and tri amines and combinations thereof wherein the ammoniated solvent agent is present in an amount of 0.1% to 5% by weight of the composition. The composition may further include a glycol ether or a mixture of glycol ethers, wherein the amount of glycol ether or glycol ether mixtures is in a range of 0.5% to 50% by weight of the composition.

In further embodiments, the presoak cleaner may include a surfactant or a mixture of surfactants, wherein the surfactant or mixture of surfactants is in an amount of 0.5% to 50% by weight of the composition and wherein the surfactant and surfactants in the mixture include anionic, nonionic, cationic and/or amphoteric surfactant.

In many embodiments, the presoak cleaner may include water to balance the weight percent to 100%. And may also have a pH in the range of about 11.0 to 13.5.

Embodiments of the presoak cleaner of the invention may be applied in a manner so the cleaning compositions may be diluted with water or other aqueous solutions, so the amount of the alkali silicate is diluted to 0.5% to 10% by weight of the diluted composition, and preferably to an amount of alkali silicate of 2% to 10% by weight of the diluted composition.

A presoak cleaner in an embodiment of the invention may be used to presoak aluminum, steel, stainless steel, ferrous metals, silicone, plastic, or coated surfaces including baking pans and sheet pans, or commonly used substrates for food preparation and cooking surfaces.

The item or surface may be rinsed after soaking without discoloring, tarnishing, or pitting of the surfaces. Cleaning compositions of the invention may be applied in a way where they may be diluted with water or another aqueous solution so the amount of alkali silicate is diluted to 0.5% to 10% by weight of the diluted composition, and preferably diluted to an amount of 2% to 10% of the diluted composition.

In many embodiments, major soil contaminants on surfaces to be cleaned by the presoak cleaner are food soils, baked on food soils, and soils resulting from the preparation, and cooking of food stuffs including greases, baked-on greases, burnt carbon, and other common residues found on surfaces in kitchens and bakeries.

Example 1A below list the ingredients of an exemplary embodiment of the presoak cleaner.

### EXAMPLE 1A

| Trade Name | Weight % | Chemical Name | CAS Number |
|---|---|---|---|
| NaOH 50% | 3.6 | Sodium Hydroxide | 1310-73-2 |
| Kasil 6 | 25.0 | Potassium Silicate | 1312-76-1 |
| MEA | 3 | Monoethanolamine | 141-43-5 |
| AOS 40% | 4.5 | Sodium Alpha Olefin Sulfonate | 68439-57-6 |
| Ammonyx MO | 2.8 | Dimethyltetradecylamine oxide | 3332-27-2 |
| Mona NF-10 | 5 | Proprietary Surfactant | N/A |
| Glycol Ether DB | 3 | Diethylene Glycol Monobutyl Ether | 112-34-5 |
| Glycol Ether EPh | 2 | Ethylene Glycol Phenyl Ether | 122-99-6 |
| Water | Q.S. to 100 | Water | 7732-18-5 |

The embodiment of the invention shown in Example 1A above is transparent and stable.

The ingredients of another exemplary embodiment of the invention are listed in Example 1B below.

### EXAMPLE 1B

| Trade Name | Weight % | Chemical Name | CAS Number |
|---|---|---|---|
| NaOH 50% | 2.3 | Sodium Hydroxide | 1310-73-2 |
| Kasil 6 | 16.2 | Potassium Silicate | 1312-76-1 |
| MEA | 2.0 | Monoethanolamine | 141-43-5 |
| AOS 40% | 5.8 | Sodium Alpha Olefin Sulfonate | 68439-57-6 |
| Neodol 91-6 | 4.6 | C9-C11 Alcohol Ethoxylate | 68439-46-3 |
| Glycol Ether DB | 1.1 | Diethylene Glycol Monobutyl Ether | 112-34-5 |
| Glycol Ether EPh | 2.6 | Ethylene Glycol Phenyl Ether | 122-99-6 |
| Water | Q.S. to 100 | Water | 7732-18-5 |

The embodiment of the invention shown in Example 1B above is also transparent and stable.

The ingredients of another exemplary embodiment of the invention are listed in Example 1C below.

### EXAMPLE 1C

| | Weight | | CAS |
|---|---|---|---|
| Trade Name | % | Chemical Name | Number |
| Methocel J12MS | 0.5 | Methyl Cellulose | 9004-687-5 |
| Sodium Hydroxide | 1.75 | Sodium Hydroxide | 1310-73-2 |
| 50% | | | |
| Kasil 6 | 0.5 | Potassium Silicate | 1312-76-1 |
| Biosoft S-100 | 3.0 | Aklyl Benzene Sulfonic | 68584-22-5 |
| | | Acid | |
| Neodol 91-6 | 2.0 | C9-C11 Alcohol Ethoxylate | 68439-46-3 |
| Glycol Ether DB | 13.0 | Diethylene Glycol | 122-34-5 |
| | | Monobutyl Ether | |
| Glycol Ether EPh | 2.0 | Ethylene Glycol Phenyl | 122-99-6 |
| | | Ether | |
| Diisopropanolamine | 4.0 | Diisopropanolamine | 110-97-4 |
| Sodium Xylene | 6.0 | Sodium Xylene Sulfonate | 1300-72-7 |
| Sulfonate | | | |
| Water | Q.S | Water | 7732-18-5 |
| | to 100 | | |

The embodiment of the invention shown in Example 1C above is also transparent and stable.

In one method of the invention, a diluted pre-soak solution is made with 1 gallon of the composition in Example 1A and the addition of 3 gallons of tap water. A heavy duty aluminum pan with baked-on grease was partially immersed in the pre-soaking solution for 24 hours at room temperature. After soaking, the pan was thoroughly rinsed with tap water without other mechanical agitation. Major improvements to the cleanliness of the pan was observed on both front and bake sides of the pan. The coating on the front side was still intact after soaking and rinse. Residual baked-on grease on the front side was found loosely attached to the pan and could be easily removed with gentle scrubbing without damaging the aluminum surface. The back side of the pan was found almost grease-free upon water rinse.

While the invention has been described with reference to exemplary structures and methods in embodiments, the invention is not intended to be limited thereto, but to extend to modifications and improvements within the scope of equivalence of such claims to the invention.

1. A presoak cleaning composition which avoids discoloration, tarnishing, or pitting of aluminum surfaces in pre-soak operations comprises one alkali metal hydroxide or a mixture of alkali metal hydroxides and one alkali silicate or a mixture of alkali silicates in the ratio of about 1:1 to 1:50 expressed as normality of hydroxide to normality of silicate, and wherein alkali silicate is present in an amount up to about 40% by weight of the composition.

2. A composition according to claim 1 wherein the alkali metal hydroxide is sodium or potassium hydroxide and the alkali silicate is potassium silicate, and wherein sodium hydroxide to potassium silicate is in the ratio of 1:1.3 to 1:1.7 expressed as normality of hydroxide to normality of silicate, and wherein potassium silicate is present in an amount of 2% to 10% by weight of the composition.

3. A composition according to claim 2, having an ammoniated agent, wherein the ammoniated agent is from the group consisting morpholine, ethanol and propanol mono, di, and tri amines and combinations thereof wherein the ammoniated solvent agent is present in an amount of 0.1% to 5% by weight of the composition.

4. A composition according to claim 3, having a glycol ether or a mixture of glycol ethers, wherein amount of glycol ether or glycol ether mixtures is in a range of 0.5% to 50% by weight of the composition.

5. A composition according to claim 4, having a surfactant or a mixture of surfactants, wherein the surfactant or mixture of surfactants is in an amount of 0.5% to 50% by weight of the composition and wherein the surfactant and surfactants in the mixture include anionic, nonionic, cationic and/or amphoteric surfactant.

6. A composition according to claim 1 wherein the alkali metal hydroxide is sodium or potassium hydroxide and the alkali silicate is potassium silicate and wherein potassium silicate is present in an amount of 2% to 10% by weight of the composition.

7. A composition according to claim 1, having an ammoniated agent, wherein the ammoniated solvent agent is from the group consisting of morpholine, ethanol and propanol mono, di, and tri amines and combinations thereof and wherein the ammoniated solvent agent is present in an amount of 0.1% to 5% by weight of the composition.

8. A composition according to claim 7, having a glycol ether or a mixture of glycol ethers, wherein amount of glycol ether or glycol ether mixtures is in a range of 0.5% to 50% by weight of the composition.

9. A composition according to claim 1, having a glycol ether or a mixture of glycol ethers, wherein amount of glycol ether or glycol ether mixtures is in a range of 0.5% to 50% by weight of the composition.

10. A composition according to claim 1, having a surfactant or a mixture of surfactants, wherein the surfactant or mixture of surfactants is in an amount of 0.5% to 50% by weight of the composition and wherein the surfactant and surfactants in the mixture include one or more of anionic, nonionic, cationic and amphoteric surfactants.

11. A composition according to claim 6, having a surfactant or a mixture of surfactants, wherein the surfactant or mixture of surfactants is in an amount of 0.5% to 50% by weight of the composition and wherein the surfactant and surfactants in the mixture include one or more of anionic, nonionic, cationic and amphoteric surfactants.

12. A composition according to claim 2, having a surfactant or a mixture of surfactants, wherein the surfactant or mixture of surfactants is in an amount of 0.5% to 50% by weight of the composition and wherein the surfactant and surfactants in the mixture include one or more of anionic, nonionic, cationic and amphoteric surfactants.

13. A composition according to claim 1 further including water.

14. A composition according to claim 1 having a pH in a range of about 11.0 to 13.5.

15. A composition according to claim 2 having a pH in a range of about 11.0 to 13.5,

16. A composition according to claim 3 having a pH in a range of about 11.0 to 13.5.

17. A process for cleaning a cooking or food preparation surface comprising selecting the composition according to claim 1, diluting the amount of the alkali silicate to 0.5% to 10% by weight of the diluted composition, applying the diluted composition to the surface and rinsing the surface without discoloring or tarnishing the surface.

18. The process of claim 17, wherein the surface includes a material selected from the group consisting of aluminum, steel, iron, silicone and plastic.

19. The process of claim 18, wherein the surface includes aluminum.

20. A process for cleaning a cooking or food preparation surface comprising selecting the composition according to claim 1, diluting the amount of the alkali silicate to 2% to 10% by weight of the diluted composition, applying the diluted composition to the surface and rinsing the surface without discoloring or tarnishing the surface.

21. The process of claim 20, wherein the surface includes a material selected from the group consisting of aluminum, steel, iron, silicone and plastic.

22. The process of claim 21, wherein the surface includes aluminum.

23. (canceled)

24. (canceled)

25. (canceled)

26. (canceled)

27. (canceled)

28. (canceled)
